(19) United States
(12) Patent Application Publication
(10) Pub. No.: US 2004/0112982 A1
(43) Pub. Date: Jun. 17, 2004

(54) Portable pressurized drywall texture sprayer

(76) Inventor: Joel A. Dilley, Encinitas, CA (US)

Correspondence Address: John R. Ross, III, P.O. Box 2138, Del Mar, CA, 92014, US

(21) Appl. No.: 10/298,376

(22) Filed: Nov. 18, 2002

(51) Int. Cl. B05B 9/08

(52) U.S. Cl. 239/152

(57) ABSTRACT

A drywall mud texture sprayer. A pressurized air canister and a drywall mud canister are connected to a backpack that a user wears on his back. The user holds a spray gun in his hands. Pressurized air from the pressurized air canister provides pressure to both the spray gun and the drywall mud canister enabling the spray gun to spray the drywall mud. In a preferred embodiment, the drywall mud canister is a 1.0 gallon canister and the pressurized air canister is a ½ gallon, 5000 psi CO₂ tank. The equipment (including the backpack, CO₂ and drywall mud) all together weighs about 25 pounds so it can easily be carried by the average worker.

The present invention relates to drywall mud texture sprayers, and in particular to portable drywall mud texture sprayers.

### BACKGROUND OF THE INVENTION

Drywall (also known as sheet rock or gypsum board) refers to a construction material composed of gypsum or plaster wrapped in paper and produced in large sheets. Drywall is commonly nailed to wall studs and is used to cover the framing, taping, coating, and finishing to make the interior walls and ceilings of a building. After drywall has been nailed to the wall studs, several coats of joint compound are applied and sanded. Then texture is usually applied to the drywall to hide imperfections. The mixture that makes up the texture is commonly referred to as drywall mud.

Currently, prior art drywall texture application devices exist. FIG. 1 shows a common device for applying drywall texture. Hose 2 is connected at one end to pressurized air canister 1. At its other end it is connected to spray gun 3. Drywall mud is contained in canister 4. Canister 4 is pressurized by air canister 5. Hose 6 is connected to canister 4 at one end and spray gun 3 at the other end. Canisters 1, 4 and 5 are all shown as resting on the ground. A user applies texture to drywall by squeezing trigger 7 of spray gun 3. Pressure from canister 5 forces drywall mud up through hose 6 and out through nozzle 8 of spray gun 3. Concurrently, pressurized air from canister 1 is also released through nozzle 8 of spray gun 3. Hence, by squeezing trigger 7 and aiming spray gun 3 at drywall, a user is able to apply texture to the drywall.

FIG. 2 shows another drywall texture application device. Hose 2 is connected at one end to pressurized air canister 1. Canister 1 is resting on the ground. At its other end it is connected to spray gun 3. Drywall mud is contained inside hopper 11. Hopper 11 is attached to the top of spray gun 3. An orifice at the bottom of hopper 11 is aligned with an orifice at the top of spray gun 3. As with the device shown in FIG. 1, a user applies texture to drywall by squeezing trigger 7 of spray gun 3. Drywall mud inside hopper 11 is gravity fed down through the bottom of hopper 11 and through nozzle 8. Concurrently, pressurized air from canister 1 is also released through nozzle 8 of spray gun 3. Hence, by squeezing trigger 7 and aiming spray gun 3 at drywall, a user is able to apply texture to the drywall.

### Some Problems with Prior Art Devices

Prior art devices have problems that have made it difficult to efficiently apply texture to drywall. For example, the device shown if FIG. 1 is difficult to maneuver. Canisters 4, 5, and 1 are heavy and need to be positioned near the area where drywall texture is to be applied. Also, hoses 2 and 6 need to be of sufficient length to reach areas that are located at a distance from canisters 4, 5 and 1. Consequently, hoses 2 and 6 are often so long that they are cumbersome and difficult to handle. They have been known to knock over household items (such as furniture, plants and other breakable items) causing costly damage.

The device shown in FIG. 2 also has significant problems. As with the device shown in FIG. 1, canister 1 is heavy and needs to be located near the job location. Also, hose 2 is often very long, cumbersome and difficult to manage. Also, because drywall mud is stored in hopper 11 it can get heavy and difficult to manage for the user. Furthermore, the drywall mud is gravity fed from hopper 11 into spray gun 3. Therefore, the drywall mud flows out quicker when hopper 11 is full than it does when hopper 11 is almost empty. This results in an inconsistent spray thickness and pattern.

### Pressurized Canisters

Prior art pressurized canisters capable of receiving and storing material to be pressurized are known. For example, FIG. 3 shows canister 22. Canister 22 a 1.0 gallon syrup canister and is manufactured by Taylor Freezers of Southern California, Inc. with offices in Commerce, Calif., part no. 045533. Canister 22 is commonly used to store ice cream flavored syrup and is constructed of stainless steel. Lid 15 is removed by lifting up on handle 16. The material to be pressurized is then poured into canister 22. Lid 15 is then placed back onto canister 22 and secured by pressing down on handle 16 so that handle 16 is in the position shown in FIG. 3. A hose from a source of pressure (for example, a pressurized air canister) is then connected to canister 22 via receptacle 17. A hose leading away from canister 22 is then connected to receptacle 18. Consequently, when canister 22 is pressurized material being stored in canister 22 may exit via the hose attached to receptacle 18.

What is needed is a better drywall texture spraying device.

### SUMMARY OF THE INVENTION

The present invention provides a drywall mud texture sprayer. A pressurized air canister and a drywall mud canister are connected to a backpack that a user wears on his back. The user holds a spray gun in his hands. Pressurized air from the pressurized air canister provides pressure to both the spray gun and the drywall mud canister enabling the spray gun to spray the drywall mud. In a preferred embodiment, the drywall mud canister is a 1 gallon canister and the pressurized air canister is a ½ gallon, 5000 psi CO₂ tank. The equipment (including the backpack, CO₂ and drywall mud) all together weighs about 25 pounds so it can easily be carried by the average worker.

### BRIEF DESCRIPTION OF THE DRAWINGS

FIG. 1 shows a prior art drywall mud texture sprayer.

FIG. 2 shows a prior art drywall mud texture sprayer.

FIG. 3 shows a prior art canister.

FIG. 4 shows a preferred embodiment of the present invention.

FIG. 5 shows the utilization of the preferred embodiment shown in FIG. 4.

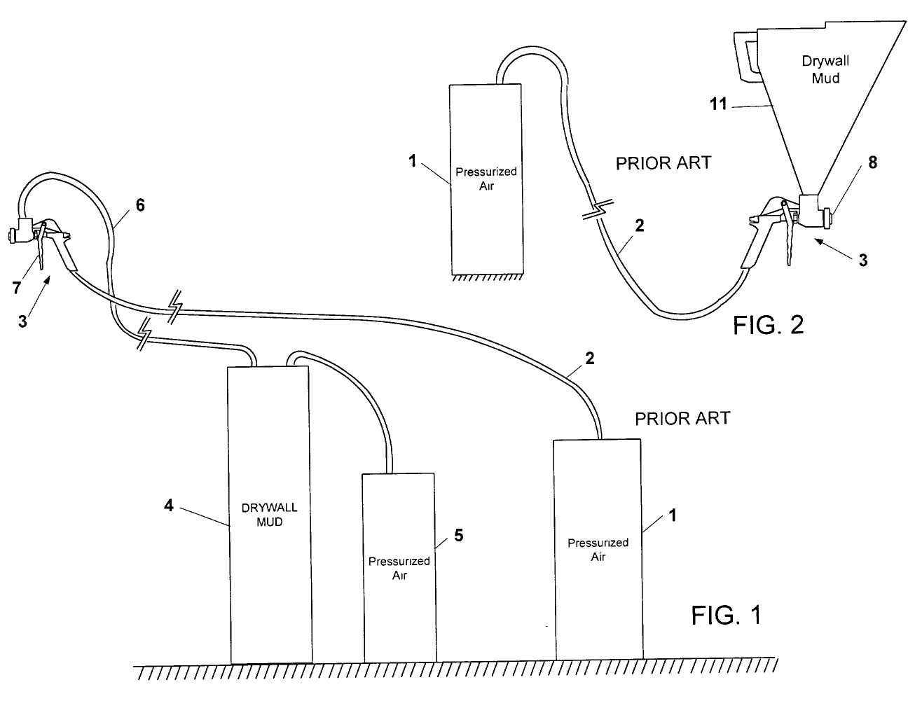

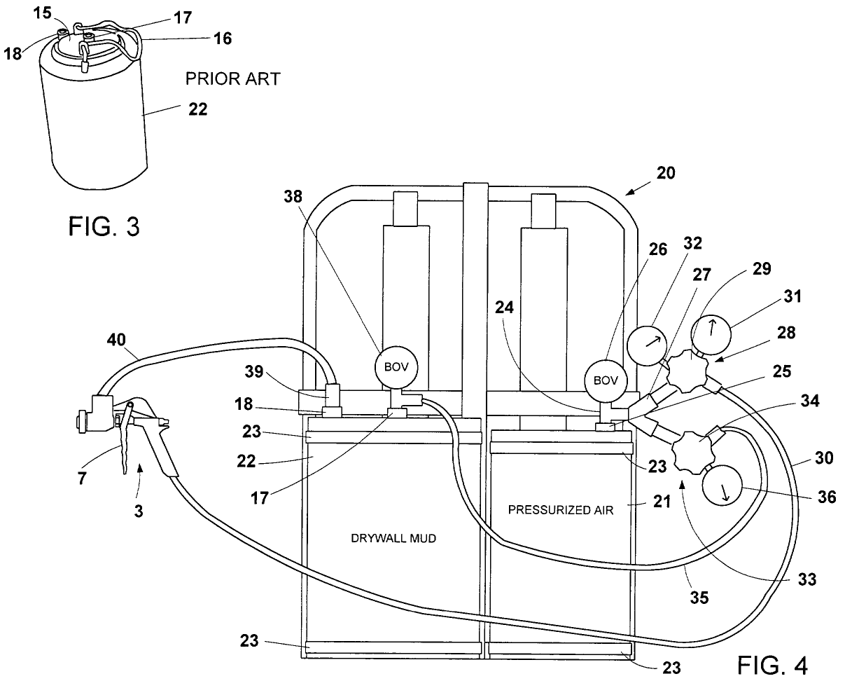

### DETAILED DESCRIPTION OF THE PREFERRED EMBODIMENT

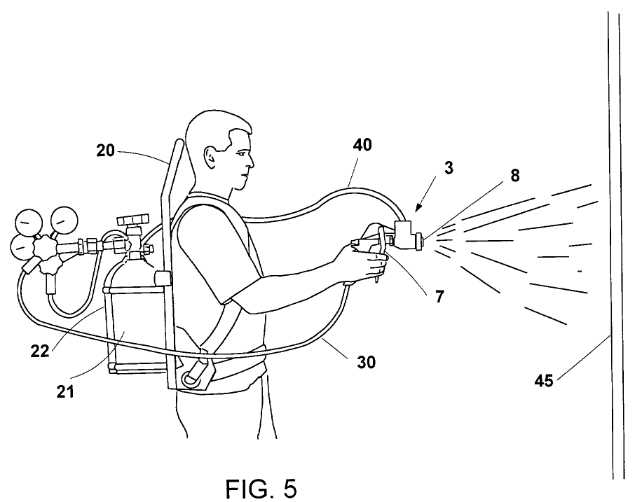

A preferred embodiment of the present invention is shown by reference to FIGS. 4-5.

Air canister 21 and drywall mud canister 22 are strapped to backpack 20 via straps 23. Preferably, air canister 21 is a ½ gallon, 5000 psi CO₂ tank and canister 22 is a 1.0 gallon tank capable of being pressurized to approximately 100 psi. When canister 21 is filled with CO₂ it weighs approximately 10 lbs. and when canister 22 is filled with drywall mud it weighs approximately 10 lbs. The total weight of backpack 20 along with a fully charged air canister 21 and a filled drywall mud canister 23 is estimated to be approximately 25 pounds. This weight is easily manageable by an adult of average strength.

Copper fitting 22 is connected to the top of air canister 21 via receptacle 25. Bleed off valve 26 is connected to the top of copper fitting 24. By turning bleed off valve 26, pressure from within air canister 21 can be released. Y-fitting 27 is connected to the end of copper fitting 24. Regulating valve assembly 28 is connected to Y-fitting 27. Regulating valve assembly includes regulating valve 29. Regulating valve 29 controls the amount of pressure that is permitted to leave regulating valve assembly 28 through hose 30. Regulating valve 29 is preferably adjusted so that hose 30 is pressurized to approximately 50 psi. At its other end, hose 30 is connected to spray gun 3. Gage 31 shows the pressure of the air inside hose 30. Gage 32 shows the pressure inside air canister 21.

Regulating valve assembly 33 is attached to the other prong of Y-fitting 27. Regulating valve assembly includes regulating valve 34. Regulating valve 34 controls the amount of pressure that is permitted to leave regulating valve assembly 33 through hose 35. Regulating valve 34 is preferably adjusted so that hose 35 is pressurized to approximately 50 psi. Gage 31 shows the pressure of the air inside hose 35.

Hose 35 is connected at its other end to copper fitting 37. Copper fitting 37 is connected to drywall mud canister 22 via receptacle 17. Bleed off valve 38 is connected to the top of copper fitting 37. By turning bleed off valve 38, pressure from within drywall mud canister 22 can be released. Pressure within drywall mud canister 22 is preferably maintained at approximately 50 psi and can be monitored via gage 36. Copper fitting 39 is attached to drywall mud canister 22 via receptacle 18. Hose 40 is connected to drywall mud canister 22 at one end and spray gun 3 at its other end.

### Operation of the Preferred Embodiment

The operation of the preferred embodiment can be seen by reference to FIGS. 4 and 5. Pressure inside air canister 21 pressurizes dry wall mud canister 22 and hose 30. Hose 30 (leading from air canister 21) is connected to the bottom of spray gun 3 and hose 40 (leading from dry wall mud canister 22) is connected to the top of spray gun 3. As shown in FIG. 5, the user squeezes trigger 7. Pressure is released and air from within pressurized air canister 21 escapes via hose 30 and out nozzle 8 of spray gun 3. Concurrently, pressurized dry wall mud from within drywall mud canister 22 also escapes via hose 40 and out nozzle 8 of spray gun 3. The pressurized air from air canister 21 sprays the drywall mud against drywall 45 so that a texturized layer is imparted to the surface of drywall 45.

The present invention is a vast improvement over the prior art. As shown in FIG. 5, a user is able to carry heavier equipment efficiently on his back via backpack 20. The user holds only the much lighter spray gun 3 is his hand. By utilization of backpack 20, the need for the long hoses that were discussed in background section is eliminated. Also, it was stated in the background section that hopper 11 (FIG. 2) gets very heavy and cumbersome when fully loaded with drywall mud. A user can quickly get fatigued using the device shown in FIG. 2. In contrast, in the present invention the user carries the drywall mud on his back. Utilization of the present invention is much less tiring.

While the above description contains many specifications, the reader should not construe these as limitations on the scope of the invention, but merely as exemplifications of preferred embodiments thereof. Those skilled in the art will envision many other possible variations are within its scope. Accordingly the reader is requested to determine the scope of the invention by the appended claims and their legal equivalents, and not by the examples which have been given.

What is claimed is:

1) A drywall mud texture sprayer, comprising:
A. a backpack,
B. a pressurized air canister connected to said backpack,
C. a drywall mud canister connected to said backpack, wherein said drywall mud canister comprises a supply of drywall mud, and
D. a spray gun for spraying said drywall mud,
wherein said pressurized air canister provides pressure to said spray gun and said drywall mud canister enabling said spray gun to spray said drywall mud.

2) The drywall mud texture sprayer as in claim 1, wherein said pressurized air canister is a CO₂ canister.

3) The drywall mud texture sprayer as in claim 1, further comprising:
A. a first air canister hose leading from said pressurized air canister to said spray gun,
B. a second air canister hose leading from said pressurized air canister to said drywall mud canister, and
C. a drywall mud canister hose leading from said drywall mud canister to said spray gun.

4) The drywall mud texture sprayer as in claim 1, further comprising:
A. a pressurized air canister bleed off valve for releasing pressure from within said pressurized air canister, and
B. a drywall mud canister bleed off valve for releasing pressure from within said drywall mud canister.

5) The drywall mud canister as in claim 1, further comprising:
A. a first pressurized air canister regulating valve for regulating the pressure from said pressurized air canister to said spray gun, and
B. a second pressurized air canister regulating valve for regulating the pressure from said pressurized air canister to said drywall mud canister.

6) A drywall mud texture sprayer, comprising:
A. a backpack means,
B. a pressurized air canister means connected to said backpack means,
C. a drywall mud canister means connected to said backpack means, wherein said drywall mud canister means comprises a supply of drywall mud, and
D. a means for spraying said drywall mud,
wherein said pressurized air canister means provides pressure to said means for spraying and said drywall mud canister means enabling said means for spraying to spray said drywall mud.

7) The drywall mud texture sprayer as in claim 6, wherein said pressurized air canister means is a CO₂ canister.

8) The drywall mud texture sprayer as in claim 6, further comprising:
A. a first air canister hose leading from said pressurized air canister means to said means for spraying,
B. a second air canister hose leading from said pressurized air canister means to said drywall mud canister means, and
C. a drywall mud canister hose leading from said drywall mud canister means to said means for spraying.

9) The drywall mud texture sprayer as in claim 6, further comprising:
A. a means for releasing pressure from within said pressurized air canister means, and
B. a means for releasing pressure from within said drywall mud canister means.

10) The drywall mud canister as in claim 6, further comprising:
A. a means for regulating the pressure from said pressurized air canister to said means for spraying, and
B. a means for regulating the pressure from said pressurized air canister means to said drywall mud canister means.
